(19) United States
(12) Patent Application Publication
(10) Pub. No.: US 2018/0183490 A1
(43) Pub. Date: Jun. 28, 2018

(54) COMMUNICATION RECEIVING APPARATUS AND METHOD FOR DETECTING TRANSMIT SYMBOLS

(71) Applicant: Ching-Yih Tseng, Milpitas, CA (US)

(72) Inventor: Ching-Yih Tseng, Milpitas, CA (US)

(21) Appl. No.: 15/903,053

(22) Filed: Feb. 23, 2018

Related U.S. Application Data
(63) Continuation-in-part of application No. 15/179,981, filed on Jun. 11, 2016, now Pat. No. 9,942,004.
(60) Provisional application No. 62/175,451, filed on Jun. 15, 2015.

(51) Int. Cl. H04B 1/7105; H04B 7/06; H04L 25/02

(52) U.S. Cl. CPC H04B 1/7105; H04B 7/0417; H04L 25/0242; H04B 7/0634

(57) ABSTRACT

A communication receiving apparatus and a method for detecting transmit symbols are provided. In the method, received signal and channel state information corresponding to the received signal are obtained. A modified Least-Square (LS) estimation according to the received signal and the channel state information is calculated. The modified LS estimation is defined as min

$${min}_{w} {‖ Aw ‖}^{2}$$

which subjects to a linearly-constrained equation C^{H}w=x−xₗₛ, C is a constraint matrix which is a matrix multiplication of a matrix A and the channel state information matrix H, w is a variable vector, x is a vector of a transmit symbol, and xₗₛ is a LS solution according to the received signal and the channel state information. The transmit symbol is determined according to the solution of the modified LS estimation. The embodiment of the disclosure is applicable to any digitally modulated communication systems, including but not limited to Multiple Input Multiple Output (MIMO) communication systems.

### CROSS-REFERENCE TO RELATED APPLICATION

This application is a continuation-in-part application of and claims the priority benefit of U.S. application Ser. No. 15/179,981, filed on Jun. 11, 2016, now pending, which claims the priority benefit of U.S. provisional application Ser. No. 62/175,451, filed on Jun. 15, 2015. The entirety of each of the above-mentioned patent applications is hereby incorporated by reference herein and made a part of this specification.

### BACKGROUND OF THE DISCLOSURE

### 1. Field of the Disclosure

The present disclosure generally relates to wireless communications, in particular, to a communication receiving apparatus and a method for detecting transmit symbols.

### 2. Description of Related Art

For a digital modulation communications system, the transmitter encodes information bits into transmit symbols, usually with forward error correction coding, and further modulates the transmit symbols into waveform to travel through the physical media (or channel) of the communication link to arrive at the receiver side. The receiver samples the incoming waveform and employs various digital receiver schemes to recover the information bits (or, equivalently, the transmit symbols) from the receiving waveform under channel and noise effects.

One of the challenging tasks for implementing a robust receiver lies in the design of a symbol detector to optimally detect the transmit symbols with a maximum likelihood criterion. The design of a maximum likelihood symbol detector is particularly challenging for a Multiple Input Multiple Output (MIMO) communications system since it involves multi-dimensional search with an exponential growth complexity when the number of input and/or output increases.

### SUMMARY OF THE DISCLOSURE

Accordingly, the present disclosure is directed to a communication receiving apparatus and a method for detecting transmit symbols, to perform optimal maximum likelihood symbol detector that is applicable to any digitally modulated communications systems, including but not limited to MIMO communications systems.

The method for detecting transmit symbols of the present disclosure, which is adapted for a communication receiving apparatus, includes the following steps. Received signal and channel state information corresponding to the received signal are obtained. A modified Least-Square (LS) estimation according to the received signal and the channel state information is calculated. The modified LS estimation is defined as

$${min}_{w} {‖ Aw ‖}^{2}$$

subject to a linearly-constrained equation C^{H}w=x−xₗₛ, where C is a constraint matrix which is a matrix multiplication of a matrix A and the inverse of the channel state information matrix H, w is a variable vector, x is a vector of transmit symbols, and xₗₛ is a LS solution according to the received signal and the channel state information. The transmit symbol vector is determined according to the solution of the modified LS estimation.

The communication receiving apparatus of the present disclosure includes a receiving circuit and a symbol detector. The receiving circuit receives signal. The symbol detector is coupled to the receiving circuit and configured for performing the following steps. Obtaining received signal and channel state information corresponding to the received signal. Calculating a modified LS estimation according to the received signal and the channel state information. The modified LS estimation is defined as

$${min}_{w} {‖ Aw ‖}^{2}$$

subject to a linearly-constrained equation C^{H}w=x−xₗₛ, C is a constraint matrix which is a matrix multiplication of a matrix A and the inverse of the channel state information matrix H, w is a variable vector, x is a vector of transmit symbols, and xₗₛ is a LS solution according to the received signal and the channel state information. Determining the transmit symbol vector according to a solution of the modified LS estimation.

Accordingly, the disclosure reformulates the maximum likelihood problem as the modified LS estimation which is a linearly constrained minimization problem. Under this linearly constrained minimization framework, the embodiments of the disclosure utilize a successive linear constraint exchange scheme that formulates a sequence of linearly constrained minimization sub-problems by selecting a reduced set of linear constraints from the full set of M constraints and by assigning proper constraint values to these selected constraints to allow the solutions to these sub-problems, combined with certain quantization and mapping operations, to converge to the optimal maximum likelihood estimate of the transmit symbol vector x at the receiver side.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a communication receiving apparatus according to an embodiment of the disclosure.

FIG. 2 illustrates a symbol detector according to an embodiment of the disclosure.

FIG. 3 illustrates a flow chart of a method for detecting transmit symbol according to an embodiment of the disclosure.

FIG. 4 illustrates an augmentizer and a flow chart thereof according to an embodiment of the disclosure.

FIG. 5 illustrates a Pivotizer and a flow chart thereof according to an embodiment of the disclosure.

FIG. 6 illustrates an embodiment of a symbol detector that has branches with each branch consisting of a maximum likelihood estimation fired up by 1-dimensional seed symbol block.

FIG. 7 illustrates an embodiment of the maximum likelihood estimation fired up by 1-dimensional seed symbol block for the m-th branch of a symbol detector.

FIG. 8 illustrates an Augmentizer-Pivotizer Unit (APU) with feedback according to an embodiment of the disclosure.

FIG. 9 illustrates an APU with seed duality according to an embodiment of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

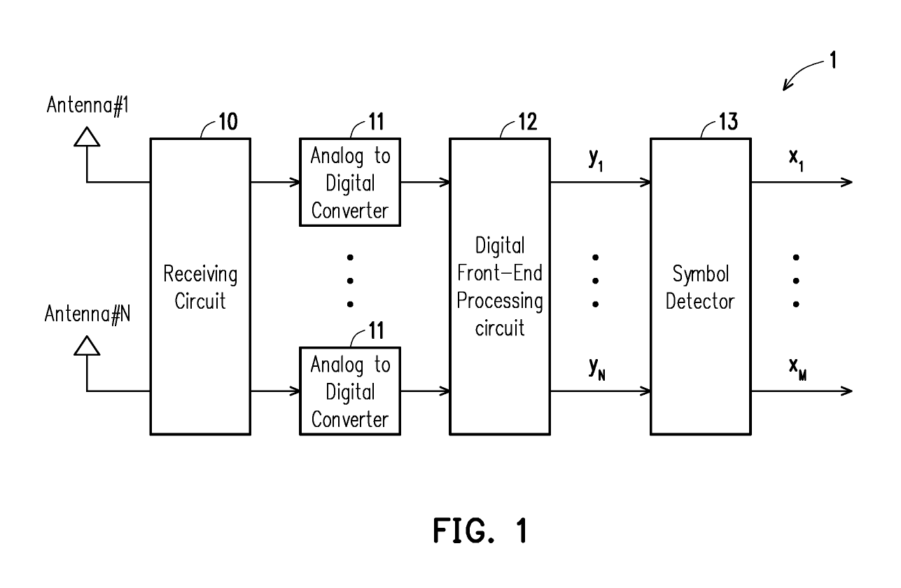

FIG. 1 illustrates a communication receiving apparatus 1 according to an embodiment of the disclosure. Referring to FIG. 1, the communication receiving apparatus 1 adapted for a MIMO communication system includes N antennas, a receiving circuit 10, N Analog to Digital (A/D) converters 11, a digital front-end processing circuit 12 and a symbol detector 13, where N is a positive integer.

The communication receiving apparatus 1 in this disclosure could represent various embodiments which for example could include but not limited to a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, and so like. In some applications, the communication receiving apparatus 1 may be a fixed computing device operating in a mobile environment, such as a bus, train, an airplane, a boat, a car, and so forth.

The receiving circuit 10 receives signals wirelessly via antennas and performs operations such as sampling, low noise amplifying, impedance matching, frequency mixing, down frequency conversion, filtering, amplifying, and so like. The A/D converters 11 are configured to convert from an analog signal format to a digital signal format during signal processing. The digital front-end processing circuit 12 is configured to perform digital base baseband signal front-end processing such as automatic gain control, carrier and timing synchronization, etc.

The functions of the symbol detector 13 could be implemented by using programmable units such as a micro-processor, a micro-controller, a DSP chips, FPGA, etc. The functions of the processing module 216 may also be implemented with separate electronic devices or ICs, and the functions performed by the symbol detector 13 may be implemented within the domain of either hardware or software. The symbol detector 13 is configured to estimate M transmit symbols {x₁, x₂, . . . , x_{M}} from N digital receiving samples {y₁, y₂, . . . , y_{N}} at every symbol period of the communication system, where M and N are positive integers.

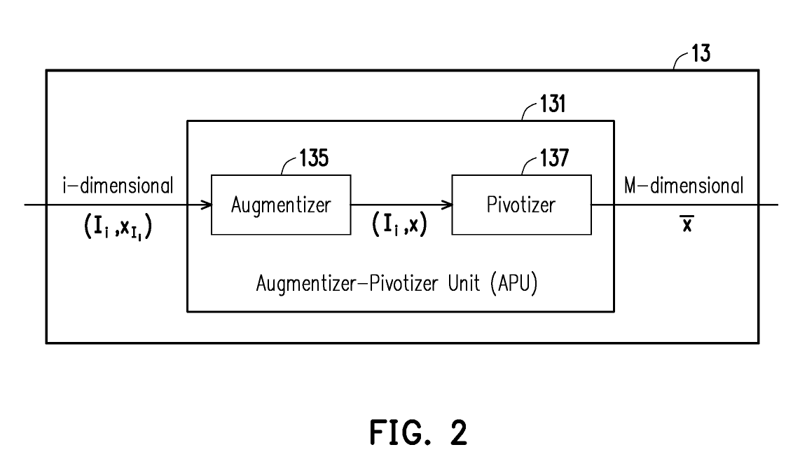

Referring to FIG. 2 which is an embodiment of the symbol detector 13. The symbol detector 13 includes an Augmentizer-Pivotizer unit (APU) 131. The APU 131 may at least include but not limited to an augmentizer 135 and a pivotizer 137. The APU 131, the augmentizer 135 and the pivotizer 137 may be implemented as hardware elements such as digital IC circuits, processor, etc. and may also be implemented as software modules or programs which are performed by a processor of the symbol detector 13.

In order to facilitate understanding of the operation process of the present embodiment, several embodiments will be provided below for describing a method for detecting transmit symbols of the disclosure. The method of the present embodiment is applicable to each element of the communication receiving apparatus 1 illustrated in FIG. 1 and each element of symbol detector 13 illustrated in FIG. 2. Hereinafter, the method of the present embodiment will be described with reference to each element and module of the communication receiving apparatus 1. Each flow of the method may be adjusted according to actual implementation scenarios, and the disclosure is not limited thereto.

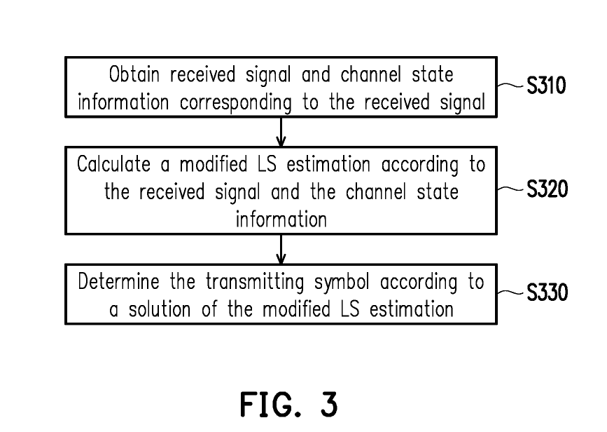

FIG. 3 is a flow chart illustrating a method for detecting transmit symbols in accordance with an embodiment of the present disclosure. After signal received by the antennas and the receiving circuit 10 and processed by the A/D converters 11 and the digital front-end processing circuit 12, the symbol detector 13 would obtain the received signal (i.e. N receiving samples {y₁, y₂, . . . , y_{N}}) and channel state information corresponding to the received signal (Step S310). The channel state information may be obtained by other external apparatus (not shown) or estimated according to any type of pilot or training sequence based channel estimations such as Minimum Mean Square Error (MMSE) estimation, Least-Square (LS) estimation, etc. The N receiving digital samples {y₁, y₂, . . . , y_{N}} and the M transmit symbols {x₁, x₂, . . . , x_{M}} at one MIMO symbol period are related in the following vector form:

y=Hx+n (1)

where the N×1 vector

$$y = [ \begin{matrix}{y}_{1} \\ {y}_{2} \\ M \\ {y}_{M}\end{matrix} ] \qquad ( 2 )$$

denotes the N receiving samples, the M×1 vector

$$x = [ \begin{matrix}{x}_{1} \\ {x}_{2} \\ M \\ {x}_{M}\end{matrix} ] \qquad ( 3 )$$

denotes the M transmit symbols, the N×N matrix

$$H = [ \begin{matrix}{h}_{11} & Λ & {h}_{1 M} \\ M & Ο & M \\ {h}_{N 1} & Λ & {h}_{NM}\end{matrix} ] \qquad ( 4 )$$

denotes the channel state information and the N×1 vector

$$n = [ \begin{matrix}{n}_{1} \\ {n}_{2} \\ M \\ {n}_{M}\end{matrix} ] \qquad ( 5 )$$

denotes the receiver additive noise. For generality, all these vectors and matrices are assumed complex-valued.

After the receipt of the received signal and the channel state information, the symbol detector 13 calculates a modified LS estimation according to the received signal and the channel state information (Step S320). Specifically, in a typical communications system, each transmit symbol is selected from a pre-designated set of complex-valued, discrete points, termed the symbol constellation. For example, the Quadrature and Amplitude Modulation (QAM) defines transmit symbols from a rectangular grid where QAM-16 modulation contains 16 constellation points, QAM-64 contains 64 constellation points, so on and so forth. This invention uses the notation, Ω, to denote the set of the constellation points in an underlining communications system.

Given the receiving sample vector y and a proper estimation of the channel state information matrix H through training sequences, the symbol detector 13 is designed to search for the transmit symbol vector x over all possible constellation points, and the corresponding optimization problem is defined as:

$${min}_{\{ {x}_{m} ∈ Ω , m = 1 , 2 , . . . , M \}} {‖ y - Hx ‖}_{2}^{2} \qquad ( 6 )$$

where ∥⋅∥₂ denotes the 2-norm of the enclosed operand. As each element of the symbol vector x is constrained to be selected from discrete points on the symbol constellation map, the solution to this maximum likelihood detector is non-trivial, especially when M is large.

The respective least-squares problem can be defined by removing the requirement for the elements of x to be discrete points on the symbol constellation map:

$${min}_{\{ {x}_{m} , m = 1 , 2 , . . . , M \}} {‖ y - Hx ‖}_{2}^{2} \qquad ( 7 )$$

For this least-squares problem, the optimal LS solution is well-known and has a closed-form expression as:

xₗₛ=(H^{H}H)⁻¹H^{H}y (8)

where H^{H} denotes the Hermitian transpose of H. Without loss of generality, the matrix H^{H}H is assumed invertible and well-conditioned in this invention as the use of “diagonal loading” technique by adding a small positive number to the diagonal elements of H^{H}H can be practically applied to precondition the H^{H}H matrix to avoid ill-conditioned issue.

The simplest approximation to the maximum likelihood solution is to “quantize” each element of xₗₛ to the nearest (measured by Euclidean distance) discrete points on the symbol constellation map:

\hat{x}ₗₛ=Q[xₗₛ] (9)

where Q[⋅] denotes the element-wise quantization of the enclosed vector to the nearest constellation point. When M>1, the “quantized” least-squares solution, \hat{x}ₗₛ rarely provides a satisfactory solution compared to the true maximum likelihood optimal solution for detecting the transmit symbols from the receiving samples corrupted by the channel and noise effect. Hence, there is a practical need to design a true maximum likelihood optimized symbol detector in a communications system, and this task is non-trivial, especially for a MIMO communications system.

This disclosure reformulates the maximum likelihood problem by including the un-quantized least-squares solution xₗₛ to the minimization objective function as:

$${min}_{\{ {x}_{m} ∈ Ω , m = 1 , 2 , . . . , M \}} \{ {‖ y - {Hx}_{ls} ‖}_{2}^{2} + {‖ H ( x - {x}_{ls} ) ‖}_{2}^{2} \} \qquad ( 10 )$$

which can be derived by use of the following property for the least-squares solution:

H^{H}(y−Hxₗₛ)=0 (11)

Note that the first term in the above reformulated maximum likelihood problem is a constant with respect to the symbol vector x and can be removed from the minimization objective function. Hence, the maximum likelihood problem can be further reformulated as:

$${min}_{\{ {x}_{m} ∈ Ω , m = 1 , 2 , . . . , M \}} {‖ H ( x - {x}_{ls} ) ‖}_{2}^{2} \qquad ( 12 )$$

Let C be an arbitrary M×M unitary matrix, the maximum likelihood problem can now be readily transformed into a linearly constrained minimization problem which is referred as the modified LS estimation in the disclosure:

$${min}_{w} {‖ Aw ‖}^{2} \qquad ( 13 )$$

subject to M linear constraints given by:

C^{H}w=f (14)

where w is a variable vector,

A=HC^{H} (15)

denotes a linear equation, and

f=x−xₗₛ (16)

and the M elements of the symbol vector x belong to the discrete constellation points:

{xₘϵΩ,m=1,2, . . . ,M} (17)

Note that the transmit symbol vector x and the least-squares solution xₗₛ now appears in the form of the constraint values f in the linear constraint specification for this reformulated maximum likelihood problem. In this disclosure, the choice of the constraint matrix C is not unique and is only required to be unitary, i.e., C^{H}=C⁻¹. C is a matrix multiplication of a matrix A and the inverse of the channel state information matrix H. For example, some practically useful choices of the constraint matrix C can be as simple as the identify matrix, I, or an unitary matrix derived from the Singular Value Decomposition (SVD) of H or the QR decomposition of H^{H}:

$$A = \{ \begin{matrix}H , & C = I , & H = HI \\ S , & C = {V}^{H} , & H = {USV}^{H} \\ {R}^{H} , & C = {Q}^{H} , & {H}^{H} = QR\end{matrix} \qquad ( 18 )$$

The above linear constraint formulation defines a full set of M linear constraints over the M-dimensional space with the corresponding constraint values specified by the differences of the transmit symbol vector x and the least-squares solution xₗₛ, denoted by the vector f. Under this linear constraint minimization framework, this disclosure utilizes a successive linear constraint exchange scheme that formulates a sequence of linearly constrained minimization sub-problems by selecting a reduced set of linear constraints from the full set of M constraints and by assigning proper constraint values to these selected constraints to allow the solutions to these sub-problems, combined with certain quantization and mapping operations, to converge to the modified LS estimation of the transmit symbol vector x at the communication receiving apparatus 1, so as to determine the transmit symbol vector according to the solution of the modified LS estimation (Step S330).

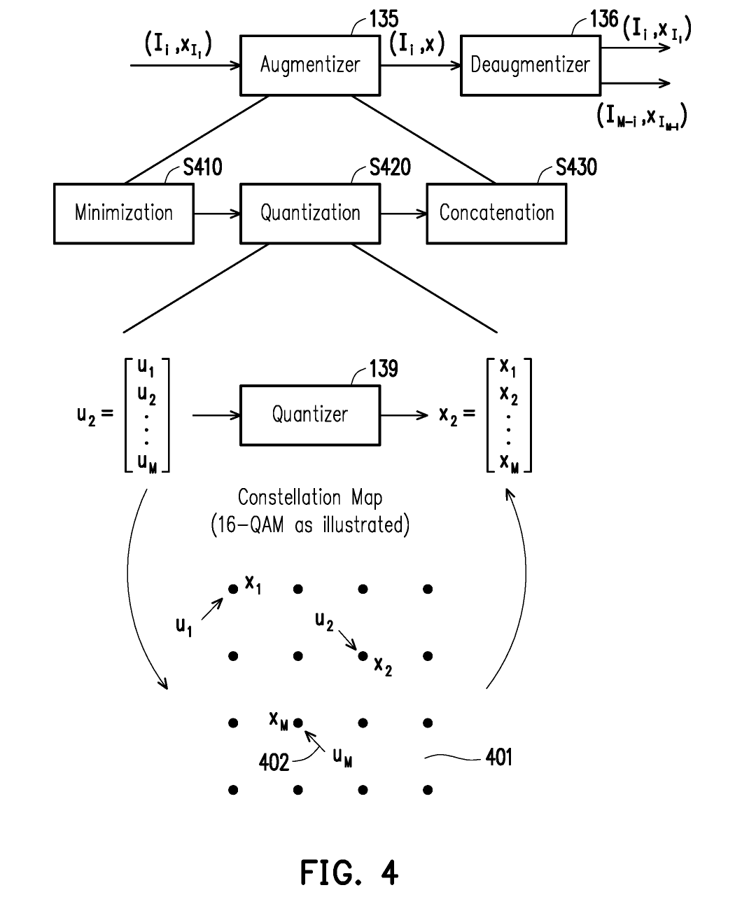

Specifically, the APU 131 constructs iteratively the vector of the transmit symbol with M dimensions by giving an i-dimensional seed symbol vector, where the i-dimensional seed symbol vector is determined from a previous iteration, and i is a positive integer less than M. Referring to FIG. 4, for each iteration, the augmentizer 135 determines an (M−i)-dimensional constraint symbol vector from the linearly-constrained equation according to the given i-dimensional seed symbol vector (S410). The APU 131 partitions the M-dimensional symbol vector x into two distinct i-dimensional symbol vector, x_{I}_{ᵢ}, and (M−i)-dimensional symbol vector, x_{I}_{_{M-1}}, specified by the selection of two sets of mutually exclusive indices, Iᵢ and I_{M-i}:

x_{I}_{ᵢ}=x(Iᵢ) (19)

x_{I}_{_{M-i}}=x(I_{M-i}) (20)

IᵢY I_{M-i}={1,2, . . . ,M} (21)

IᵢI I_{M-i}=ø (22)

where Iᵢ contains indices and I_{M-i} contains (M−i) indices with i selected as an integer between 1 and M. The order of the indices in these two index sets has no significance in deriving the symbol detector 13 and can be assumed in ascending order without loss of generality. For example, for M=8, i=3 and the M-dimensional symbol vector given by:

$$x = [ \begin{matrix}{x}_{1} \\ {x}_{2} \\ {x}_{3} \\ \begin{matrix}{x}_{4} \\ {x}_{5} \\ {x}_{6} \\ {x}_{7} \\ {x}_{8}\end{matrix}\end{matrix} ] . \qquad ( 23 )$$

When the two mutually exclusive index sets are chosen as Iᵢ={1,3,5} and I_{M-i}={2,4,6,8}, the two reduced dimensional symbol vectors are given by:

$$\begin{matrix}{X}_{{I}_{i}} = [ \begin{matrix}{x}_{1} \\ {x}_{3} \\ {x}_{5}\end{matrix} ] , & ( 24 ) \\ {X}_{{I}_{M - i}} = [ \begin{matrix}{x}_{2} \\ {x}_{4} \\ \begin{matrix}{x}_{6} \\ {x}_{7} \\ {x}_{8}\end{matrix}\end{matrix} ] & ( 25 )\end{matrix}$$

With this partition, the augmentizer 135 constructs an M-dimensional symbol vector x from a given i-dimensional symbol vector x_{I}_{ᵢ} by solving the modified LS estimation with i linear constraints. The i-dimensional symbol vector x_{I}_{ᵢ} used as the input in step S410 is termed the seed symbol vector, the induced (M−i)-dimensional symbol vector x_{I}_{_{M-i}} is termed the seed complementary symbol vector and the output M-dimensional symbol vector x is term the augmented symbol vector. In particular, the modified LS estimation (i.e., linearly-constrained minimization problem) would be defined as:

$${min}_{w} {w}^{H} {A}^{H} Aw \qquad ( 26 )$$

subject to i linear constraints on w, given by:

C_{I}_{ᵢ}^{H}w=x_{I}_{ᵢ}−x_{ls,I}_{ᵢ} (27)

where

C_{I}_{ᵢ}=C(:,Iᵢ) (28)

consists of the i columns of constraint matrix C indexed by Iᵢ and

x_{ls,I}_{ᵢ}=xₗₛ(Iᵢ) (29)

consists of the i elements of xₗₛ indexed by Iᵢ.

A closed-form solution for the optimal w to this modified LS estimation would be given by:

w_{I}_{ᵢ}=C_{I}_{ᵢ}f_{I}_{ᵢ}−C_{I}_{_{M-i}}(C_{I}_{_{M-i}}^{H}A^{H}AC_{I}_{_{M-i}})⁻¹C_{I}_{_{M-i}}^{H}A^{H}AC_{I}_{ᵢ}f_{I}_{ᵢ} (30)

where

f_{I}_{ᵢ}=x_{I}_{ᵢ}−x_{ls,I}_{ᵢ} (31)

and

C_{I}_{_{M-i}}=C(:,I_{M-i}) (32)

contains the (M−i) columns of constraint matrix C indexed by I_{M-i}. Define an (M−i)-dimensional constraint symbol vector u_{I}_{_{M-i}} as:

u_{I}_{ᵢ}=C_{I}_{_{M-i}}^{H}w_{I}_{ᵢ}w_{I}_{ᵢ}+x_{ls,I}_{_{M-i}}=−(C_{I}_{_{M-i}}^{H}A^{H}AC_{I}_{_{M-i}})⁻¹C_{I}_{_{M-i}}^{H}A^{H}AC_{I}_{ᵢ}f_{I}_{ᵢ}+x_{ls,I}_{_{M-i}} (33)

where

x_{ls,I}_{_{M-i}}=xₗₛ(I_{M-i}) (34)

contains the (M−i) elements of xₗₛ indexed by I_{M-i}. The (M−i)-dimensional seed complementary symbol vector x_{I}_{_{M-i}} is determined by quantizing the (M−i)-dimensional constraint symbol vector u_{I}_{_{M-i}} element-wise to the nearest constellation points (Step S420):

x_{I}_{_{M-i}}=Q└u_{I}_{_{M-i}}┘ (35)

where a quantizer 139 of augmentizer 135 would perform the quantization of each element of the enclosed vector to the nearest constellation point 402 with a pre-defined constellation map 401. Note that the constellation map 401 of 16-QAM is merely an example for description, and the constellation map may be modified according to QAM-64, Quadrature Phase Shift Keying (QPSK), or other modulations in other embodiments. In addition, when the augmentizer 135 computes C_{I}_{_{M-i}}^{H}w_{I}_{ᵢ} in the above derivation, the unitary property of the constraint matrix C is applied, i.e., C_{I}_{_{M-i}}^{H}C_{I}_{ᵢ}=0 and C_{I}_{_{M-i}}^{H}C_{I}_{_{M-i}}=1.

Then, the given i-dimensional seed symbol vector x_{I}_{ᵢ} and the (M−i)-dimensional complementary symbol vector x_{I}_{_{M-i}} are concatenated to form the M-dimensional augmented symbol vector x (Step S430). For example, the aforementioned vector (24) and (25) (i.e., [x₁, x₃, x₅]^{T} and [x₂, x₄, x₆, x₇, x₈]^{T}) are concatenated to from the vector (23) (i.e., [x₁, x₂, x₃, x₄, x₅, x₇, x₈]^{T}).

As illustrated in FIG. 4, this procedure of generating the M-dimensional augmented symbol vector x from the i-dimensional seed symbol vector x_{I}_{ᵢ} is referred to as the augmentation process in the description of this disclosure and is represented by a block termed the augmentizer 135 which consists of the minimization S410, quantization S420 and concatenation S430 steps; The reverse process of generating x_{I}_{ᵢ} and x_{I}_{_{M-i}} back from (Iᵢ, x) is referred to as the deaugmentation process and is represented by a deaugmentizer 136 of the symbol detector 13. Note that the augmented symbol vector x is uniquely determined by (Iᵢ, x_{I}_{ᵢ}), (A, C, xₗₛ) and the symbol constellation map Ω.

Then, the M-dimensional symbol vector x would be mapped to its neighboring symbol vector of the same dimension, and this procedure is donated by x̅=P[x] that satisfies the following property: By using any combination of (M−1) elements of x̅ as an (M−1)-dimensional seed symbol vector, the remaining 1-element of x̅ is the corresponding seed complementary symbol vector. The symbol vector x that satisfies this property is termed a pivoting symbol vector. In other words, the pivoting symbol vector x̅ is an augmented symbol vector generated by using any combination of (M−1) elements of pivoting symbol vector x̅ as an (M−1)-dimensional seed symbol vector. Note that this generation must hold true for all M possible combinations of selecting (M−1) elements out of pivoting symbol vector x̅ where the order of the (M−1) selected elements is irrelevant.

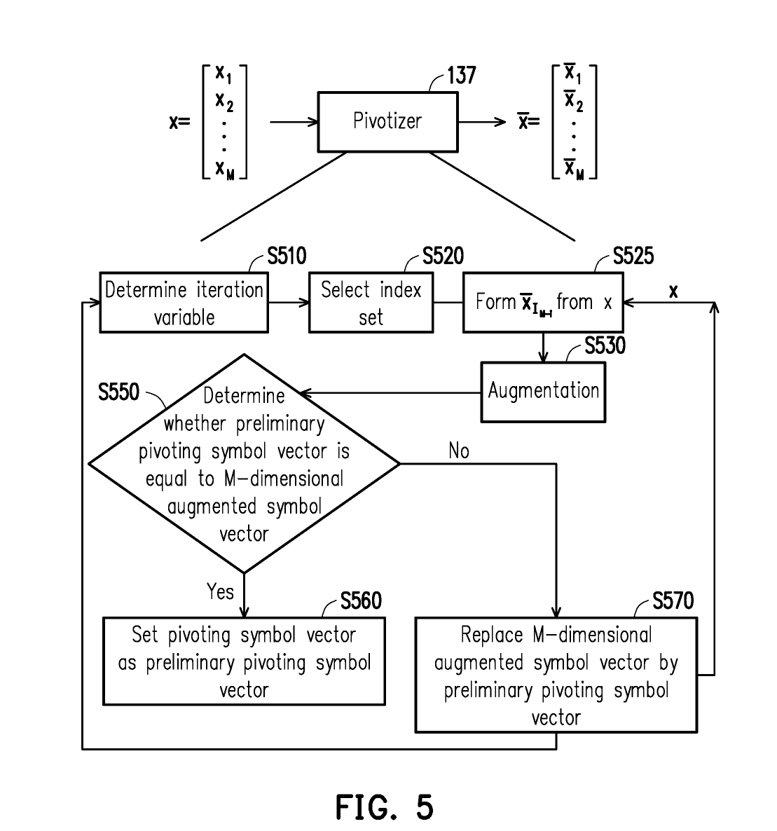

A systematic procedure illustrated in FIG. 5 is applied to map an arbitrarily given M-dimensional symbol vector x to its neighboring pivoting symbol vector x̅. As shown in FIG. 5, this procedure is referred to as the pivoting procedure in the description of this disclosure and performed by the pivotizer 137. This pivoting procedure starts with the M-dimensional augmented symbol vector x and an iteration variable k set to 0 as the initialization condition. In each iteration, the iteration variable k is modulo by M and increment by 1 (Step S510). The index set I_{M-1} is selected as taking the index of iteration variable k out from the indices {1, 2, . . . , M} (Step S520) and is used to form x̅_{I}_{_{M-i}} from the M-dimensional augmented symbol vector x (Step S525). The augmentizer 135 is invoked to construct a preliminary pivoting symbol vector x̅ based on the input (I_{M-1}, x̅_{I}_{_{M-i}}) (Step S530), where a 1-dimensional constraint symbol from the linearly-constrained equation is determined according to an (M−1)-dimensional seed symbol vector x̅_{I}_{_{M-i}} determined from the M-dimensional augmented symbol vector x according to the index set I_{M-1}, the 1-dimensional constraint symbol is quantized to determine a 1-dimensional seed complementary symbol, and a preliminary pivoting symbol vector x is formed by concatenating the (M−1)-dimensional seed symbol vector x̅_{I}_{_{M-i}} and the 1-dimensional seed complementary symbol. Then, the pivotizer 137 determines whether the preliminary pivoting symbol vector x̅ is equal to the M-dimensional augmented symbol vector x (Step S550). If this preliminary pivoting symbol vector x̅ equals the M-dimensional augmented symbol vector x and the equality condition holds true for M consecutive iterations where k has looped through 1 to M, the pivotizer 137 terminates with i found to be the neighboring pivoting symbol vector to the original x (Step S560); otherwise, the M-dimensional augmented symbol vector x is replaced by preliminary pivoting symbol vector x̅ (Step S570) and the next iteration starts with the iteration variable k modulo by M and increment by 1 (back to Step S510). It should be apparent to those skilled in the art that the above pivoting procedure is only illustration of specific embodiment of the pivotizer 137. Any modified pivoting procedures should fall in the scope of this disclosure provided that the outcome of the procedure is a symbol vector that satisfies the pivoting property as define in this disclosure. For example, the arrangement of selecting the index k out from the M indices {1, 2, . . . , M} from 1 to M in ascending order is shown in FIG. 5, whereas descending order or any other index selection order is also applicable provided that the index k is looped through the overall M indices.

Referring to FIG. 2, the augmentizer 135 and the pivotizer 137 are combined together to form the APU 131, which is used as the core computational unit or circuit in the embodiments of this disclosure to compute for the optimal maximum likelihood transmit symbols given the receiving samples at the communication receiving apparatus 1.

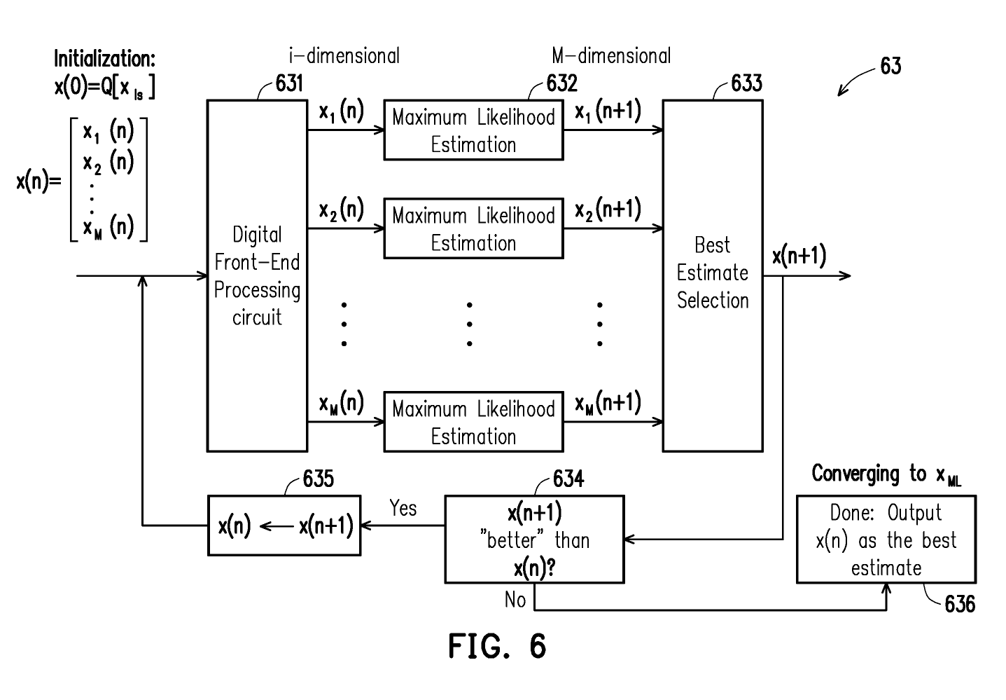

On the basis of the inventive spirit of the above embodiment, the symbol detector 13 could be modified. Referring to FIG. 6, another embodiment of this disclosure employs M-branch of digital logic symbol detector 63, which can be implemented as electronic circuit or computer program, to detect the maximum likelihood M-dimensional symbol vector, denoted by x_{ML}. Each block 631-636 also can be implemented as electronic circuit or computer program. Each branch is used to generate a sequence of symbol vector estimates such that the estimates from one or more of these branches converge to x_{ML}. To fire up the search procedure for the M-branch in FIG. 6, an initial estimate of x_{ML} is required. A convenient way to generate this initial estimate x(0) is to compute the least-squares estimate and apply direct quantization on each element of the least-squares estimate to its nearest constellation point, i.e.,

x(0)=Q[xₗₛ] (36).

In other words, the M-dimensional seed symbol vector is a quantized vector of the LS solution in the first iteration. Given H and y, the computation of this initial estimate is relatively simple and straightforward. Any other choices of initial estimate are also applicable to this search procedure in the embodiment of this disclosure.

Specifically, the symbol detector 63 starts with x(n)=x(0) and uses the vector-to-scalar splitter 631 to splitting the M elements of x(n) into M branches where each branch is fired up with the corresponding element of x(n), to form M 1-dimensional seed symbols. For the m-th branch, the 1-dimensional symbol vector xₘ(n) is used to fire up the maximum likelihood estimate block 632 to generate the M-dimensional symbol vector xₘ(n+1). The Best Estimate Selection block 633 is then applied to select the “best” estimate out of {xₘ(n+1), m=1, 2, . . . , M} from the M branches and the resulting best estimate is denoted by x(n+1). A symbol vector is deemed “better” than another symbol vector provided that the error (or objective) function, ∥H(x−xₗₛ)∥₂², associated with this symbol vector is smaller. The best estimate for this iteration, x(n+1), is compared to that for the last iteration, x(n) (block 634). If it is better, a better estimate has been found and x(n) is replaced by x(n+1) (block 635) to start another iteration of search, it means the i-dimensional seed symbol vector is set as one of the M 1-dimensional seed symbols for M branch estimations, and the M-dimensional seed symbol vector is an estimated result of a previous iteration in other iterations. Otherwise, the search procedure terminates with the “best” estimated result selected as x(n) (block 636), it means the i-dimensional seed symbol vector remains the same.

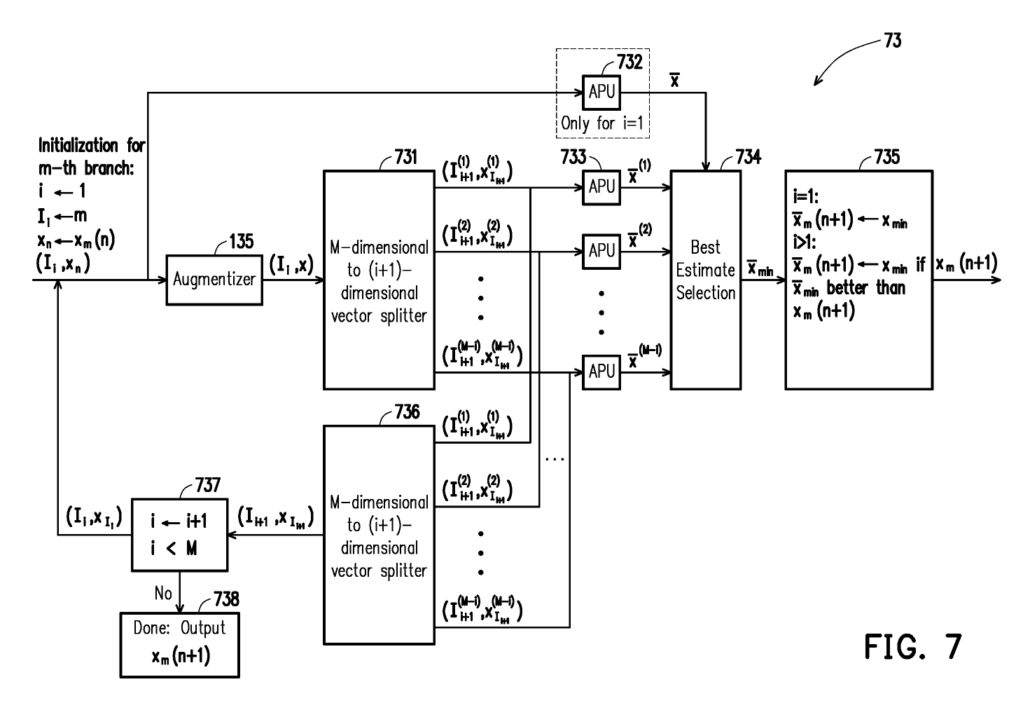

In one embodiment of this disclosure, the block 632 of FIG. 6 for m-th branch can be implemented as illustrated in FIG. 7. For one particular iteration n in the m-th branch, the maximum likelihood estimation block 73 in FIG. 7 starts with initializing i as 1 and the 1-dimensional seed symbol vector as (Iᵢ,X_{I}_{ᵢ})←(m,xₘ(n)). Then, the augmentizer 135 constructs the M-dimensional augmented symbol vector x according to a corresponding 1-dimensional seed symbols; an M-dimensional to (i+1)-dimensional vector splitter 731 is then applied to map the M-dimensional augmented symbol vector x into (M−i) pairs of (i+1)-dimensional seed symbol vectors (Iᵢ₊₁^{(l)},xᵢ₊₁^{(l)}) defined as:

Iᵢ₊₁^{(l)}={Iᵢ,I_{M-i}(l)} (37)

and

$${x}_{i + 1}^{( l )} = [ \begin{matrix}{x}_{{I}_{i}} \\ {x}_{{I}_{M - i}} ( l )\end{matrix} ] \qquad ( 38 )$$

for l=1, 2, . . . , M−i. Each one of these (Iᵢ₊₁^{(l)},xᵢ₊₁^{(l)}) is fed into one APU 733 to compute for a pivoting symbol vector x̅^{(l)}, respectively. For i=1, the i-th dimensional seed vector (Iᵢ, X_{I}_{ᵢ}) is also fed into an APU 732 to compute for a pivoting symbol vector x̅. The Best Estimate Selection block 734 then selects the best estimated result from these pivoting symbol vectors and the output is denoted as x̅ₘᵢₙ. For i=1, the output for this branch is temporarily assigned as: xₘ(n+1)←x̅ₘᵢₙ (block 735). As i progresses from 1 to M−1, x̅ₘᵢₙ is compared with the xₘ(n+1) computed for (i−1) and xₘ(n+1) for i is updated as x̅ₘᵢₙ if x̅ₘᵢₙ is better than xₘ(n+1) (block 735). The “Select (i+1)-dimensional seed symbol vector” block 736 is used to select one out of the (M−i) (i+1)-dimensional seed symbol vectors where a minimum error criterion is used to make the selection, i.e., the corresponding linearly constrained minimization sub-problem for (Iᵢ₊₁^{(l)},xᵢ₊₁^{(l)}) that yields the minimum error is selected as (Iᵢ₊₁,X_{I}_{ᵢ₊₁}), this seed symbol vector (Iᵢ₊₁,X_{I}_{ᵢ₊₁}) is then used as the input to the augmentizer 135 in FIG. 7 to start the next loop of estimation procedure by increment i by 1 until i reaches M (block 737). When i reaches M, the output for this branch in this iteration is generated as xₘ(n+1) (block 738).

Having described one embodiment of this disclosure, there are various modifications that can be made without departing from the scope of the disclosure.

Several modification schemes that are applicable for deriving additional embodiments of this disclosure are provided below.

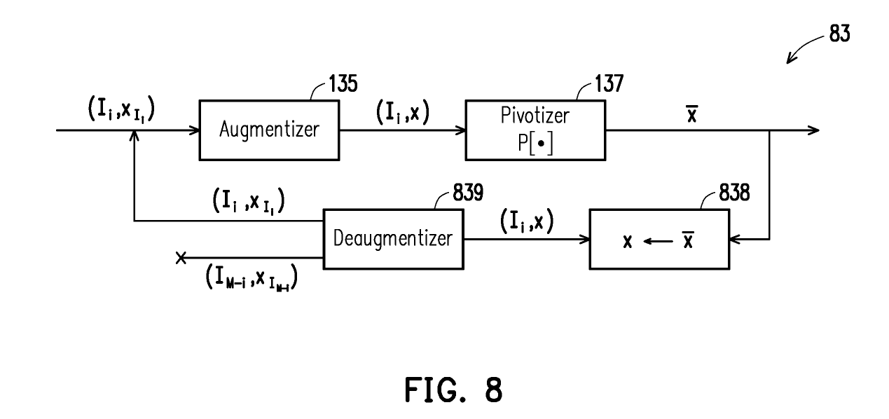

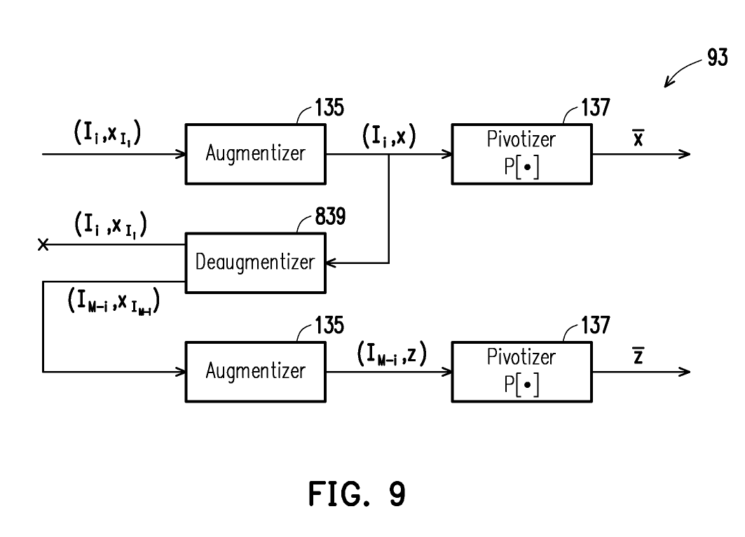

The APU 131 as shown in FIG. 2 is used to compute a pivoting symbol vector from an i-dimensional seed symbol vector with the augmentizer 135 and the pivotizer 137. Extensions of this basic APU 131 can be derived by use of feedback as shown in FIG. 8 and seed duality as shown in FIG. 9, respectively. Referring to FIG. 8, a symbol detector 83 including APU 131 with feedback takes the pivoting symbol vector outputted from the pivotizer 137 as input (block 838) of the deaugmentizes 839 (which performs the aforementioned deaugmentation process, i.e. deaugmentizer 136 of FIG. 4) to obtain an i-dimensional feedback seed symbol vector to re-compute a new M-dimensional augmented symbol vector and a new pivoting symbol vector. This feedback can continue for a finite number of times or until the process converges, i.e., when two consecutive output pivoting symbol vectors are equal. The best pivoting symbol vector generated through this feedback process can be used as the final output of the APU.

On the other hand, referring to FIG. 9, a symbol detector 93 including the APU 131 with seed duality generates one pivoting symbol vector x̅ by use of the i-dimensional seed symbol vector as in the basic APU 131 (including the augmentizer 135 and the pivotizer 137) and an additional pivoting symbol vector z̅ by use of the (M−i)-dimensional feedback seed complementary symbol vector de-augmented by the deaugmentizer 839, the M-dimensional augmented symbol determined by another augmentizer 135 according to the M-dimensional augmented symbol, and an additional pivoting symbol vector generated by another pivotizer 137. More types of APU can also be derived by the mixture of using the mechanism of feedback and seed duality or any other applicable mechanism. Any type of APU that can generate one or more pivoting symbol vectors from an i-dimensional seed symbol vector can be adopted to derive additional embodiments of this disclosure.

In addition, for each iteration n in the embodiment of FIG. 6, the embodiment has branches corresponding to m=1, 2, . . . , M. For the embodiment of each of these M branches in FIG. 7, there are M−1 loopback levels corresponding to i=1, 2, . . . , M−1. A sequence of pivoting symbol vectors is generated during one iteration n for the two variable loops specified by m and i. When a better estimated result of pivoting symbol vector is encountered in any particular (m, i) loop, the iteration n can be terminated prematurely, without having to reach all possible (m, i) loops, by using this pivoting symbol vector as the better estimated result for this iteration and proceed to the next iteration n+1. This iteration premature termination strategy can be adopted to derive additional embodiments of this disclosure.

Furthermore, for each iteration n in the embodiment of FIG. 6, the embodiment has branches corresponding to m=1, 2, . . . , M. For the embodiment of each of these M branches in FIG. 7, there are M−1 loopback levels corresponding to i=1, 2, . . . , M−1. Over all the loops specified by the three variables (n, m, i), any two identical i-dimensional seed symbol vectors (Iᵢ, X_{I}_{ᵢ}) to the input of the augmentizer 135 in FIG. 7 generate the same pivoting symbol vectors at the output of the Best Estimate Selection 734 and hence all repetition of i-dimensional seed symbol vectors over (n, m, i) loops at the input of the augmentizer 135 can be avoided to save computation resource without performance degradation. A simple store-and-compare mechanism to keep track of all i-dimensional seed symbol vectors appearing at the input of the augmentizer 135 in FIG. 7 can be adopted to derive additional embodiments of this disclosure.

Besides, in the embodiment of FIG. 7, the “Select (i+1) dimensional seed symbol vector” block 736 is used to select one out of (M−i) seed symbol vectors to pass onto the next loopback level of i+1. This block 736 can be modified to allow the selection of more than one seed symbol vectors to pass onto the next loopback level at the cost of more computational complexity. By properly buffering the output of this block 736, the selection of more than one seed symbol vectors can be implemented and adopted to derive additional embodiments of this disclosure. In addition, besides the described minimum error selection criterion, other selection criterion can also be adopted to derive additional embodiments of this invention.

Furthermore, in the embodiment of FIG. 7, there are (M−i) (i+1)-dimensional seed symbol vectors that are generated at the output of the “M-dimensional to (i+1)-dimensional vector splitter” block 731 and are fed into (M−i) APUs 733 to generate (M−i) pivoting symbol vectors. By selecting only a subset of these (M−i) (i+1)-dimensional seed symbol vectors to be fed into the APUs 733, the computational complexity can be reduced. This computational complexity reduction strategy with a proper subset selection criterion can be adopted to derive additional embodiments of this disclosure.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for detecting transmit symbols, adapted for a communication receiving apparatus, the method comprising:
obtaining received signal and channel state information corresponding to the received signal;
calculating a modified least-square (LS) estimation according to the received signal and the channel state information, wherein the modified LS estimation is defined as
$${min}_{w} {‖ Aw ‖}^{2}$$
which subjects to a linearly-constrained equation C^{H}w=x−xₗₛ, C is a constraint matrix which is a matrix multiplication of a matrix A and the inverse of the channel state information matrix H, w is a variable vector, x is a vector of a transmit symbol, and xₗₛ is a LS solution according to the received signal and the channel state information; and
determining the transmit symbol according to a solution of the modified LS estimation.

2. The method for detecting transmit symbols according to claim 1, wherein the step of calculating the modified LS estimation according to the received signal and the channel state information comprising:
constructing iteratively the vector of the transmit symbol with M dimensions by giving an i-dimensional seed symbol vector, wherein the i-dimensional seed symbol vector is determined from a previous iteration, and M and i are positive integers where i is less than M.

3. The method for detecting transmit symbols according to claim 2, wherein the step of constructing iteratively the vector of the transmit symbol vector with M dimensions by giving an i-dimensional seed symbol vector comprising:
for each iteration:
determining an (M−i)-dimensional constraint symbol vector from the linearly-constrained equation according to the given i-dimensional seed symbol vector;
quantizing the (M−i)-dimensional constraint symbol vector to determine an (M−i)-dimensional seed complementary symbol vector; and
concatenating the given i-dimensional seed symbol vector and the (M−i)-dimensional complementary symbol vector to form an M-dimensional augmented symbol vector.

4. The method for detecting transmit symbols according to claim 3, after the step of forming the M-dimensional augmented symbol vector, the method further comprising:
pivoting the M-dimensional augmented symbol vector to obtain a pivoting symbol vector with M dimensions, wherein an (M−1)-dimensional seed symbol vector is used as any combination of (M−1) elements of the pivoting symbol vector, a 1-dimensional seed complementary symbol is used as remaining 1-element of the pivoting symbol vector.

5. The method for detecting transmit symbols according to claim 4, wherein the step of pivoting the M-dimensional augmented symbol vector to obtain the pivoting symbol vector with M dimensions comprising:
determining an iteration variable;
selecting an index set according to the iteration variable;
determining a 1-dimensional constraint symbol from the linearly-constrained equation according to an (M−1)-dimensional seed symbol vector, wherein the (M−1)-dimensional seed symbol vector is determined from the M-dimensional augmented symbol vector according to the index set;
quantizing the 1-dimensional constraint symbol to determine a 1-dimensional seed complementary symbol;
concatenating the (M−1)-dimensional seed symbol vector and the 1-dimensional seed complementary symbol to form a preliminary pivoting symbol vector;
determining whether the preliminary pivoting symbol vector is equal to the M-dimensional augmented symbol vector;
setting the pivoting symbol vector as the preliminary pivoting symbol vector in response to the preliminary pivoting symbol vector being equal to the M-dimensional augmented symbol vector for M consecutive iterations; and
replacing the M-dimensional augmented symbol vector by the preliminary pivoting symbol vector in response to the preliminary pivoting symbol vector being not equal to the M-dimensional augmented symbol vector for any iteration.

6. The method for detecting transmit symbols according to claim 5, wherein the iteration variable is modulo by M and increment by 1 for a next iteration.

7. The method for detecting transmit symbols according to claim 2, wherein the step of calculating the modified LS estimation according to the received signal and the channel state information comprising:
splitting an M-dimensional seed symbol vector into M 1-dimensional seed symbols, wherein the M-dimensional seed symbol vector is a quantized vector of the LS solution in a first iteration, and the M-dimensional seed symbol vector is an estimated result of a previous iteration in other iterations; and
setting the i-dimensional seed symbol vector as one of the M 1-dimensional seed symbols for M branch estimations, respectively.

8. The method for detecting transmit symbols according to claim 7, after the step of setting the i-dimensional seed symbol vector as one of the M 1-dimensional seed symbols for M branch estimations, the method further comprising:
for each of the M branch estimations:
determining an iteration variable as i, which is a positive integer;
constructing an M-dimensional seed symbol vector according to a corresponding 1-dimensional seed symbols;
splitting the M-dimensional seed symbol vector into (M−i) (i+1)-dimensional seed symbol vectors;
determining (M−i) pivoting symbol vectors according to the (M−i) (i+1)-dimensional seed symbol vectors, respectively;
selecting one of the (M-j) pivoting symbol vectors as an estimated result; and
comparing the estimated result with another estimated result selected in a previous iteration.

9. The method for detecting transmit symbols according to claim 4, after the step of obtaining the pivoting symbol vector with M dimensions, the method further comprising:
de-augmenting the pivoting symbol vector to obtain an i-dimensional feedback seed symbol vector; and
determining the M-dimensional augmented symbol vector and the pivoting symbol vector according to the i-dimensional feedback seed symbol vector.

10. The method for detecting transmit symbols according to claim 4, after the step of obtaining the pivoting symbol vector with M dimensions, the method further comprising:
de-augmenting the pivoting symbol vector to obtain an (M−i)-dimensional feedback seed complementary symbol vector;
determining the M-dimensional augmented symbol according to the (M−i)-dimensional feedback seed complementary symbol vector; and
pivoting the M-dimensional augmented symbol vector to obtain an additional pivoting symbol vector.

11. A communication receiving apparatus for detecting transmit symbols, comprising:
a receiving circuit, receiving signal; and
a symbol detector, coupled to the receiving circuit and configured for:
obtaining received signal and channel state information corresponding to the received signal;
calculating a modified LS estimation according to the received signal and the channel state information, wherein the modified LS estimation is defined as
$${min}_{w} {‖ Aw ‖}^{2}$$
which subjects to a linearly-constrained equation C^{H}w=x−xₗₛ, C is a constraint matrix which is a matrix multiplication of a matrix A and the channel state information matrix H, w is a variable vector, x is a vector of a transmit symbol, and xₗₛ is a LS solution according to the received signal and the channel state information; and
determining the transmit symbol according to a solution of the modified LS estimation.

12. The communication receiving apparatus according to claim 11, wherein the symbol detector comprises an augmentizer-pivotizer unit, and the augmentizer-pivorizer unit is configured for:
constructing the vector of the transmit symbol with M dimensions by giving an i-dimensional seed symbol vector iteratively, wherein the i-dimensional seed symbol vector is determined from a previous iteration, and M and i are positive integers where i is less than M.

13. The communication receiving apparatus according to claim 12, wherein the augmentizer-pivorizer unit comprises an augmentizer, and the augmentizer is configured for:
for each iteration:
determining an (M−i)-dimensional constraint symbol vector from the linearly-constrained equation according to the given i-dimensional seed symbol vector;
quantizing the (M−i)-dimensional constraint symbol vector to determine an (M−i)-dimensional seed complementary symbol vector; and
concatenating the given i-dimensional seed symbol vector and the (M−i)-dimensional complementary symbol vector to form an M-dimensional augmented symbol vector.

14. The communication receiving apparatus according to claim 13, wherein the augmentizer-pivorizer unit comprises a pivotizer, and the pivotizer is configured for:
pivoting the M-dimensional augmented symbol vector to obtain a pivoting symbol vector with M dimensions, wherein an (M−1)-dimensional seed symbol vector is used as any combination of (M−1) elements of the pivoting symbol vector, a 1-dimensional seed complementary symbol is used as remaining 1-element of the pivoting symbol vector.

15. The communication receiving apparatus according to claim 14, wherein the pivotizer is configured for:
determining an iteration variable;
selecting an index set according to the iteration variable;
determining a 1-dimensional constraint symbol from the linearly-constrained equation according to an (M−1)-dimensional seed symbol vector, wherein the (M−1)-dimensional seed symbol vector is determined from the M-dimensional augmented symbol vector according to the index set;
quantizing the 1-dimensional constraint symbol to determine a 1-dimensional seed complementary symbol;
concatenating the (M−1)-dimensional seed symbol vector and the 1-dimensional seed complementary symbol to form a preliminary pivoting symbol vector;
determining whether the preliminary pivoting symbol vector is equal to the M-dimensional augmented symbol vector;
setting the pivoting symbol vector as the preliminary pivoting symbol vector in response to the preliminary pivoting symbol vector being equal to the M-dimensional augmented symbol vector for M consecutive iterations; and
replacing the M-dimensional augmented symbol vector by the preliminary pivoting symbol vector in response to the preliminary pivoting symbol vector being not equal to the M-dimensional augmented symbol vector for any iteration.

16. The communication receiving apparatus according to claim 15, wherein the iteration variable is modulo by M and increment by 1 for a next iteration.

17. The communication receiving apparatus according to claim 12, wherein the symbol detector is configured for:
splitting an M-dimensional seed symbol vector into M 1-dimensional seed symbols, wherein the M-dimensional seed symbol vector is a quantized vector of the LS solution; and
setting the i-dimensional seed symbol vector as one of the M 1-dimensional seed symbols for M branch estimations, respectively.

18. The communication receiving apparatus according to claim 17, wherein the symbol detector is configured for:
for each of the M branch estimations:
determining an iteration variable as i, which is a positive integer;
constructing an M-dimensional seed symbol vector according to a corresponding 1-dimensional seed symbols;
splitting the M-dimensional seed symbol vector into (M−i) (i+1)-dimensional seed symbol vectors;
determining (M−i) pivoting symbol vectors according to the (M−i) (i+1)-dimensional seed symbol vectors, respectively;
selecting one of the (M−i) pivoting symbol vectors as an estimated result; and
comparing the estimated result with another estimated result selected in a previous iteration.

19. The communication receiving apparatus according to claim 14, wherein the symbol detector is configured for:
de-augmenting the pivoting symbol vector to obtain an i-dimensional feedback seed symbol vector; and
determining the M-dimensional augmented symbol vector and the pivoting symbol vector according to the i-dimensional feedback seed symbol vector.

20. The communication receiving apparatus according to claim 14, wherein the symbol detector is configured for:
de-augmenting the pivoting symbol vector to obtain an (M−i)-dimensional feedback seed complementary symbol vector;
determining the M-dimensional augmented symbol according to the (M−i)-dimensional feedback seed complementary symbol vector; and
pivoting the M-dimensional augmented symbol vector to obtain an additional pivoting symbol vector.
